(19) United States
(12) Patent Application Publication
(10) Pub. No.: US 2026/0201217 A1
(43) Pub. Date: Jul. 16, 2026

(54) FORMULATION FOR STARCH-BASED ADHESIVES

(71) Applicant: Jatko, LLC, Jasper, TN (US)

(72) Inventors: Duane Thomas Johnson, Jasper, TN (US); Katherine E. Jordan, Jasper, TN (US)

(21) Appl. No.: 19/131,451

(22) PCT Filed: Nov. 15, 2023
(86) PCT No.: PCT/US2023/079737

§ 371 Date: May 20, 2025

Related U.S. Application Data
(60) Provisional application No. 63/384,510, filed on Nov. 21, 2022.

(51) Int. Cl. C09J 103/02; C08K 3/22; C08K 3/38; C08K 5/053

(52) U.S. Cl. CPC C09J 103/02; C08K 3/22; C08K 3/38; C08K 5/053

(57) ABSTRACT

Disclosed herein is a formulation for use as a starch-based adhesive, comprising: one or more metal hydroxides, one or more boron-containing compounds, a polyhydroxy compound, and water, its manufacture, and uses thereof.

### RELATED APPLICATION

This application is being filed on Nov. 15, 2023, as a PCT International Application and claims the benefit of and priority to U.S. Provisional Application No. 63/384,510, filed on Nov. 21, 2022, the subject matter of which is hereby incorporated by reference.

### BACKGROUND

Starch-based adhesives are used extensively in the paper container business. Corrugated cardboard is a common example where a flat linerboard made of kraft and/or recycled paper is joined to a fluted paperboard using an adhesive. This starch-based adhesive is then dried, which fixes the fluted and flat paperboard together.

Starch is a naturally occurring polymeric carbohydrate consisting of linear and branched amylose units. Starch is insoluble in cold water. However, when added to hot water, the starch crystals swell and burst allowing the polymer to dissolve in the water. This forms a high viscosity gel or paste. The temperature at which this occurs is called the gelatinization temperature, or gel point. Depending on the starch, this will typically occur between 54° C. to 85° C. Gelatinization temperatures can vary depending on the amount of water present, pH, types and concentration of salts, sugars, fats, and proteins.

Starch-based adhesives are usually made on site by the Stein-Hall process. See, e.g., Bauer. In this process a small amount of starch is gelatinized to form a viscous carrier fluid. Typically, the gel is made using hot water and sodium hydroxide to help lower the gelatinization temperature. A much larger amount of starch is then added to this gel and mixed to form a slurry. Boric acid, or sodium borate salts are then added to help improve the tack of the adhesive. Many other additives may also be added at this point to help improve the water resistance, the strength and tack, flexibility and processibility of the adhesive.

To help minimize the labor requirements and the potential for human error, it is desired to create a single additive of caustic soda and boric acid that accurately provides the desired ratios of caustic soda to boron to starch. As boric acid is considered to be a reproductive health hazard, it is usually desired that the operators at a plant avoid handling the dry powder as the fines can produce a breathing hazard. However, sodium hydroxide and boric acid react to form sodium borate salts that have poor solubility in cold water. For example, the most common borate salt, borax (sodium borate decahydrate, Na₂B₄O₇·10H₂O), is only 5.8% soluble in water at 25° C. This would require a large amount of water in the product, which is not financially viable logistically.

Other types of borate salts have higher solubility in cold water. For example, potassium tetraborate (K₂B₄O₇·4H₂O) has a solubility of 17.8% by weight in water at 25° C. Potassium tetraborate is formed by the reaction of potassium hydroxide and boric acid. Unfortunately, potassium hydroxide has much less gelation “power” and requires a larger amount to gel the starch at the same temperature as would sodium hydroxide. In addition, potassium hydroxide is more expensive than sodium hydroxide. See e.g., Messenger.

Disclosed herein is a formulation that overcomes recognized problems associated with, for example, borate-containing compositions, which has significantly improved borate solubility, solution stability, freeze protection, and overall adhesion performance.

### SUMMARY

Disclosed herein is a formulation for use as a starch-based adhesive, comprising: one or more metal hydroxides, one or more boron-containing compounds, a polyhydroxy compound, and water, its manufacture, and uses thereof.

### DETAILED DESCRIPTION

Disclosed herein is a formulation for use as a starch-based adhesive, comprising: one or more metal hydroxides, one or more of a boron-containing compounds, one or more polyhydroxy compounds, and water, its manufacture, and uses thereof.

In one aspect of the formulation disclosed herein, the one or more metal hydroxides comprises any suitable metal hydroxide, including, for example, lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum(III) hydroxide, cobalt(II) hydroxide, copper(I) hydroxide, copper(II) hydroxide, iron(II) hydroxide, iron(III) hydroxide, nickel(II) hydroxide, zinc(II) hydroxide, zirconium(IV) hydroxide, lutetium(III) hydroxide, lanthanum(III) hydroxide, cerium(III) hydroxide, cerium(IV) hydroxide, and the like.

In yet another aspect of the formulation disclosed herein, the one or more metal hydroxides comprises an alkali metal hydroxide, an alkaline earth metal hydroxide, or a combination thereof.

In a further aspect of the formulation disclosed herein, the one or more metal hydroxide comprises lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, or a combination thereof.

In yet another aspect of the formulation disclosed herein, the one or more metal hydroxide comprises sodium hydroxide, potassium hydroxide, magnesium hydroxide, calcium hydroxide, or other metal hydroxides known to aid in the gelling of starch in solution.

One will appreciate that the one or more metal hydroxides used in the manufacture of the formulation may be either solid or a part of an aqueous solution.

In yet another aspect of the formulation disclosed herein, the one or more metal hydroxide comprises sodium hydroxide, potassium hydroxide, or a combination thereof.

In yet an aspect of the formulation disclosed herein, the one or more metal hydroxide comprises sodium hydroxide.

The formulation may comprise one or more metal hydroxides in an amount of from about 5% to about 80% based on the total weight of the formulation, and all values in between, including, for example, about 10%, about 15%, about 20%, about 25%, about 30%, about 35%, about 40%, about 45%, about 50%, about 55%, about 60%, about 65%, about 70%, and about 75%.

In one aspect of the formulation disclosed herein, the formulation comprises one or more boron-containing compounds. Examples of boron-containing compounds include, but are not limited to, boric acid (boric acid (B(OH)₃)), or a salt thereof, or a hydrated salt thereof, including, for example, borax (e.g., Na₂B₄O₇ and hydrates thereof (e.g., Na₂B₄O₇·10H₂O, Na₂B₄O₅(OH)₄·8H₂O, and the like)), sodium tetrahydroxyborate NaB(OH)₄, orthoborates (e.g., trisodium orthoborate (Na₃BO₃), diborates (e.g., magnesium diborate (Mg₂B₂O₅ (viz., suanite), sodium perborate (Na₂H₄B₂O₈), and the like), metaborates (e.g., sodium metaborate (Na₃B₃O₆)), triborates (e.g., calcium aluminum triborate (CaAlB₃O₇ (viz., johachidolite)), tetraborates (e.g., lithium tetraborate (Li₆B₄O₉), potassium tetraborate (K₂B₄O₇·4H₂O), and the like), pentaborates (e.g., sodium pentaborate (Na₂B₁₀O₁₆·10H₂O)), octaborates (e.g., disodium octaborate (Na₂B₈O₁₃)), or other metal salts of borates known to increase the tack of starch-based adhesives, including a combination of any one of the boron-containing compounds identified herein.

In one aspect of the formulation disclosed herein, the one or more boron-containing compounds is present in an amount of about 0.1 to about 25% based on the total weight of the formulation, and all values in between, including, for example, about 0.5%, about 1.0%, about 1.5%, about 2.0%, about 2.5%, about 3.0%, about 3.5%, about 4.0%, about 4.5%, about 5.0%, about 5.5%, about 6.0%, about 6.5%, about 7.0%, about 7.5%, about 8.0%, about 8.5%, about 9.0%, about 9.5%, about 10.0%, about 10.5%, about 11.0%, about 11.5%, about 12.0%, about 12.5%, about 13.0%, about 13.5%, about 14.0%, about 14.5%, about 15.0%, about 15.5%, about 16.0%, about 16.5%, about 17.0%, about 17.5%, about 18.0%, about 18.5%, about 19.0%, about 19.5%, about 20.0%, about 20.5%, about 21.0%, about 21.5%, about 22.0%, about 22.5%, about 23.0%, about 23.5%, about 24.0%, and about 24.5%.

In one aspect of the formulation disclosed herein, the formulation comprises one or more polyhydroxy compounds. Examples of a polyhydroxy compounds include, but are not limited to glycerol, diglycerol, ethylene glycol, propylene glycol, 1,3-propanediol, butanetriol, methylene glycol, a saccharide (e.g., glucose, fructose, galactose, xylose, ribose, sucrose, lactose, maltose, trehalose, cellosbiose, chitobiose, nigerotriose, maltotriose, melezitose, maltotriulose, raffinose, kestose, lychnose, maltotetraose, nigerotetaose, nystose, sesamose, stachyose, and the like); a sugar alcohol (e.g., erythritol, threitol, arabitol, xylitol, ribitol, mannitol, sorbitol, galactitol, fucitol, iditol, inositol, volemitol, isomalt, maltitol, lactitol, maltotriitol, maltotetraitol, pentaerythritol, polyglycitol, and the like); a polyethylene glycol (e.g., HOCH₂—(CH₂OCH₂)ₘ—CH₂OH, where m represents the average number of oxyethylene groups, e.g., m=4.2 (viz., PEG 200), 6.4 (viz., PEG 300), 8.7 (viz., PEG 400), and the like), a polypropylene glycol, a glycol ether, a hydrocolloid (e.g., acacia, agar, alginic acid, carbomer, carmellose sodium, carrageenan, dextrin, gelatin, gellan gum, guar gum, hydroxyethyl cellulose, hydroxypropyl cellulose, hydroxypropyl starch, hypromellose, maltodextrin, methylcellulose, modified starch, pectin, poloxamer, poly(vinyl alcohol), polycarbophil, potassium alginate, povidone, pregelatinized starch, propylene glycol alginate, sodium alginate, tragacanth, xanthan gum, and the like), or other polyhydroxy compounds that may increase the solubility of borates in solution.

Not to be limited by theory, it is believed that a polyhydroxy compound may form a chelate with the boron-containing compound thereby increasing the solubility of the boron-containing compound in solution. For instance, borax exhibits a water solubility of about 5.8% by weight, but borax exhibits a solubility of about is 41.6% by weight (in ethylene glycol) and about 52.6% by weight (in a 98.5% glycerol solution). Accordingly, an advantageous feature of the formulation disclosed herein includes, but is not limited to, achieving a relatively high content of boron-containing compound that does not precipitate when exposed to low temperatures (e.g., 40° C. below 0° C. (i.e., about −40° C.). This is particularly advantageous for shipping and/or storage of the formulation under colder ambient conditions.

In certain aspects, it may be desirable to have certain mole ratio of the one or more polyhydroxy compounds (“PHC”) to the one or more boron-containing compounds (“BCC”), including for example, a mole ratio of PHC-to-BCC of about 0.1 to about 3.0, including all values in between, such as, for example, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, and about 2.9.

In one aspect, the formulation disclosed herein comprises one or more metal hydroxides in an amount of from about 10% to about 50% based on the total weight of the formulation; one or more boron-containing compounds in an amount of about 2 to about 20% based on the total weight of the formulation; one or more polyhydroxy compounds in an amount of from about 2% to about 10%; and water.

In another aspect, the formulation disclosed herein comprises one or more metal hydroxides in an amount of from about 30% to about 50% based on the total weight of the formulation; one or more boron-containing compounds in an amount of about 5 to about 15% based on the total weight of the formulation; one or more polyhydroxy compounds in an amount of from about 2% to about 10%; and water.

In yet another aspect, the formulation disclosed herein comprises one or more metal hydroxides in an amount of from about 30% to about 45% based on the total weight of the formulation; one or more boron-containing compounds in an amount of about 5 to about 12% based on the total weight of the formulation; one or more polyhydroxy compounds in an amount of from about 4% to about 8%; and water.

In a further aspect, the formulation disclosed herein comprises one or more metal hydroxides in an amount of from about 35% to about 40% based on the total weight of the formulation; one or more boron-containing compounds in an amount of about 5 to about 9% based on the total weight of the formulation; one or more polyhydroxy compounds in an amount of from about 5% to about 6%; and water.

In a further aspect, the formulation disclosed herein comprises one or more metal hydroxides in an amount of from about 35% to about 40% based on the total weight of the formulation; one or more boron-containing compounds in an amount of about 5 to about 9% based on the total weight of the formulation; one or more polyhydroxy compounds in an amount of from about 5% to about 6%; and water.

One will appreciate that the formulation disclosed herein may comprise the recited ingredients plus additional ingredients, including, for example, the formulation disclosed herein may comprise other additives, such as water repellants, gelation aids and stabilizers, sodium silicate, defoamers, preservatives, and the like.

Alternatively, one will appreciate that the formulation disclosed may consist of the recited ingredients.

A first alternative aspect of the formulation disclosed herein consists of one or more metal hydroxides in an amount of from about 5% to about 80% based on the total weight of the formulation; one or more boron-containing compounds in an amount of about 0.1 to about 25% based on the total weight of the formulation; one or more polyhydroxy compounds in an amount of from about 0.1% to about 25%; and water.

A second alternative aspect of the formulation disclosed herein consists of one or more metal hydroxides in an amount of from about 10% to about 50% based on the total weight of the formulation; one or more boron-containing compounds in an amount of about 2 to about 20% based on the total weight of the formulation; one or more polyhydroxy compounds in an amount of from about 2% to about 10%; and water.

A third alternative aspect of the formulation disclosed herein consists of one or more metal hydroxides in an amount of from about 30% to about 50% based on the total weight of the formulation; one or more boron-containing compounds in an amount of about 5 to about 15% based on the total weight of the formulation; one or more polyhydroxy compounds in an amount of from about 2% to about 10%; and water.

A fourth alternative aspect of the formulation disclosed herein consists of one or more metal hydroxides in an amount of from about 30% to about 45% based on the total weight of the formulation; one or more boron-containing compounds in an amount of about 5 to about 12% based on the total weight of the formulation; one or more polyhydroxy compounds in an amount of from about 4% to about 8%; and water.

A fifth alternative aspect of the formulation disclosed herein consists of one or more metal hydroxides in an amount of from about 35% to about 40% based on the total weight of the formulation; one or more boron-containing compounds in an amount of about 5 to about 9% based on the total weight of the formulation; one or more polyhydroxy compounds in an amount of from about 5% to about 6%; and water.

A sixth alternative aspect of the formulation disclosed herein consists of one or more metal hydroxides in an amount of from about 35% to about 40% based on the total weight of the formulation; one or more boron-containing compounds in an amount of about 5 to about 9% based on the total weight of the formulation; one or more polyhydroxy compounds in an amount of from about 5% to about 6%; and water.

Also disclosed herein includes processes for preparing the formulation disclosed herein, as well as processes for preparing a corrugated board, a box comprising the corrugated board, or a paper product (e.g., paper bag).

One aspect relates to a process for preparing the formulation disclosed herein, which comprises (1) mixing one or more polyhydroxy compounds and water to obtain a first solution, (2) mixing one or more metal hydroxides and the first solution to obtain a second solution, which may be optionally heated to a temperature of from about 60° C. to about 100° C. (e.g., about 80° C.), (3) mixing a boron-containing compound and the second solution to obtain a third solution, which may be optionally heated to a temperature of from about 60° C. to about 100° C. (e.g., about 80° C.), and (4) optionally cooling the third solution to room temperature. The process for preparing the formulation may further comprise dispensing the third solution into a suitable container, e.g., an intermediate bulk container.

An additional aspect relates to a process for preparing a corrugated board or a paper product according to conventional methods, including, for example, the Stein-Hall process, to obtain a corrugated board (and cardboard box) or a paper product (and a paper bag).

### EXAMPLES

The information that follows illustrates certain aspects of the formulation disclosed herein and is not meant to limit the scope of the claimed subject matter. The exemplified embodiments relate generally to formulations comprising one or more metal hydroxides, one or more boron-containing compounds, optionally, one or more polyhydroxy compounds, and water. Unless stated otherwise, recited percentages refer to percent by weight of component relative to the total amount of the formulation.

### Example 1

An amount of glycerin equal to 5.35% of the total solution weight was added to an amount of water equal to 12.4% by weight of total solution and stirred for 10 minutes. An amount of a 50% w/w solution of sodium hydroxide equal to 75.2% of the total solution weight was added to this solution and heated to 80° C. An amount of boric acid equal to 7.1% of the total solution weight was added to this solution and allowed to stir for 30 minutes at 80° C. The solution was then cooled to room temperature.

This solution was found to not freeze at −36° C. for several months. The solution was stable at room temperature for at least three months without any precipitation or the formation of haze.

### Example 2

An amount of glycerin equal to 4.6% of the total solution weight was added to an amount of water equal to 49.9% by weight of total solution and stirred for 10 minutes. An amount of solid sodium hydroxide equal to 37.0% of the total solution weight was added to this solution and heated to 80° C. An amount of boric acid equal to 8.5% of the total solution weight was added to this solution and allowed to stir for 30 minutes at 80° C. The solution was then cooled to room temperature.

This solution was found to not freeze at −36° C. for several months. The solution was stable at room temperature for at least three months without any precipitation or the formation of haze.

### Example 3

An amount of glycerin equal to 5.4% of the total solution weight was added to an amount of water equal to 49.75% by weight of total solution and stirred for 10 minutes. An amount of solid potassium hydroxide equal to 37.8% of the total solution weight was added to this solution and heated to 80° C. An amount of boric acid equal to 7.1% of the total solution weight was added to this solution and allowed to stir for 30 minutes. The solution was then cooled to room temperature.

This solution was found to not freeze at −36° C. for several months. The solution was stable at room temperature for at least three months without any precipitation or the formation of haze.

### Example 4

An amount of solid sodium hydroxide equal to 42% of the total weight of solution was added to an amount of water equal to 50% of the total solution weight and stirred for 10 minutes. To this solution was added an amount of boric acid equal to 8.0% of the total solution weight and heated to 80° C. under agitation for 30 minutes. The solution was then cooled to room temperature.

This solution precipitated within 24 hours and froze at −36° C. within 24 hours.

### Example 5

An amount of glycerin equal to 7.6% of the total solution weight was added to an amount of water equal to 49.89% by weight of total solution and stirred for 10 minutes. An amount of solid sodium hydroxide equal to 31.85% of the total solution weight was added to this solution and heated to 80° C. An amount of boric acid equal to 10.66% of the total solution weight was added to this solution and allowed to stir for 30 minutes.

This solution was found to not freeze at −36° C. for several months. The solution was stable at room temperature for at least three months without any precipitation or the formation of haze.

### Example 6

An amount of ethylene glycol equal to 4.34% of the total solution weight was added to an amount of water equal to 59.86% by weight of total solution and stirred for 10 minutes. An amount of solid sodium hydroxide equal to 30.1% of the total solution weight was added to this solution and heated to 80° C. An amount of boric acid equal to 5.7% of the total solution weight was added to this solution and allowed to stir for 30 minutes.

The solution was stable at room temperature for at least one month without any precipitation or the formation of haze. However, it did freeze at −36° after five days.

### Example 7

An amount of propylene glycol equal to 4.34% of the total solution weight was added to an amount of water equal to 59.86% by weight of total solution and stirred for 10 minutes. An amount of solid sodium hydroxide equal to 30.1% of the total solution weight was added to this solution and heated to 80° C. An amount of boric acid equal to 5.7% of the total solution weight was added to this solution and allowed to stir for 30 minutes.

The solution was stable at room temperature for at least one month without any precipitation or the formation of haze. However, it did freeze at −36° C. after 24 hours.

### Example 8

An amount of diethylene glycol equal to 4.34% of the total solution weight was added to an amount of water equal to 59.86% by weight of total solution and stirred for 10 minutes. An amount of solid sodium hydroxide equal to 30.1% of the total solution weight was added to this solution and heated to 80° C. An amount of boric acid equal to 5.7% of the total solution weight was added to this solution and allowed to stir for 30 minutes.

This solution did not freeze at −36° C. for several months. The solution was stable at room temperature for at least three months without any precipitation or the formation of haze. However, the solution did turn a slight yellow color that darkened over time.

### Additional Aspects

Aspect 1. A formulation for use as a starch-based adhesive, comprising: one or more metal hydroxides in an amount of from about 5% to about 80% based on the total weight of the formulation; one or more boron-containing compounds in an amount of about 0.1 to about 25% based on the total weight of the formulation; one or more polyhydroxy compounds in an amount of from about 0.1% to about 25%; and water.

Aspect 2. The formulation of aspect 1, wherein the one or more metal hydroxides is present in an amount of from about 10% to about 50% based on the total weight of the formulation.

Aspect 3. The formulation of any one of the preceding aspects, wherein the one or more metal hydroxides is present in an amount of from about 30% to about 50% based on the total weight of the formulation.

Aspect 4. The formulation of any one of the preceding aspects, wherein the one or more metal hydroxides is present in an amount of from about 30% to about 45% based on the total weight of the formulation.

Aspect 5. The formulation of any one of the preceding aspects, wherein the one or more metal hydroxides is present in an amount of from about 35% to about 40% based on the total weight of the formulation.

Aspect 6. The formulation of any one of the preceding aspects, wherein the one or more boron-containing compounds is present in an amount of about 2 to about 20% based on the total weight of the formulation.

Aspect 7. The formulation of any one of the preceding aspects, wherein the one or more boron-containing compounds is present in an amount of about 5 to about 15% based on the total weight of the formulation.

Aspect 8. The formulation of any one of the preceding aspects, wherein the one or more boron-containing compounds is present in an amount of about 5 to about 12% based on the total weight of the formulation.

Aspect 9. The formulation of any one of the preceding aspects, wherein the one or more boron-containing compounds is present in an amount of about 5 to about 12% based on the total weight of the formulation.

Aspect 10. The formulation of any one of the preceding aspects, wherein the one or more boron-containing compounds is present in an amount of about 5 to about 9% based on the total weight of the formulation.

Aspect 11. The formulation of any one of the preceding aspects, wherein the one or more polyhydroxy compounds is present in an amount of about 2 to about 10% based on the total weight of the formulation.

Aspect 12. The formulation of any one of the preceding aspects, wherein the one or more polyhydroxy compounds is present in an amount of about 4 to about 8% based on the total weight of the formulation.

Aspect 13. The formulation of any one of the preceding aspects, wherein the one or more polyhydroxy compounds is present in an amount of about 5 to about 6% based on the total weight of the formulation.

Aspect 14. A product comprising the formulation of any one of the preceding aspects, wherein the product comprises a cardboard box or a paper bag.

Aspect 15. A process for preparing the formulation of any one of aspects 1-13, which comprises (1) mixing one or more polyhydroxy compounds and water to obtain a first solution, (2) mixing one or more metal hydroxides and the first solution to obtain a second solution, which may be optionally heated to a temperature of from about 60° C. to about 100° C. (e.g., about 80° C.), (3) mixing a boron-containing compound and the second solution to obtain a third solution, which may be optionally heated to a temperature of from about 60° C. to about 100° C. (e.g., about 80° C.), and (4) optionally cooling the third solution to room temperature.

### CITED INFORMATION

U.S. Published Patent Application No. US 2017/0121572A1, Additive for a Starch Adhesive Composition, published on Jul. 10, 2018 to Messenger et al. of CEL Chemical & Supply, Inc. (“Messenger”).
U.S. Pat. No. 2,102,937 A, Plyboard Adhesive, issued on Dec. 21, 1937, to J. V. Bauer of Stein, Hall Manufacturing Co. (“Bauer”).

The subject matter of U.S. Provisional Ser. No. 63/384,510 , filed on Nov. 21, 2022, is incorporated by reference in its entirety. Cited information identified herein is incorporated by reference in its entirety to the extent necessary. If there is a difference in meaning between the incorporated terms and the terms disclosed herein, the meaning of the terms disclosed herein will control.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

1. A formulation for use as a starch-based adhesive, comprising:
one or more metal hydroxides in an amount of from about 5% to about 80% based on the total weight of the formulation;
one or more boron-containing compounds in an amount of about 0.1 to about 25% based on the total weight of the formulation;
one or more polyhydroxy compounds in an amount of from about 0.1% to about 25%; and
water.

2. The formulation of claim 1, wherein the one or more metal hydroxides is present in an amount of from about 10% to about 50% based on the total weight of the formulation.

3. The formulation of claim 1, wherein the one or more metal hydroxides is present in an amount of from about 30% to about 50% based on the total weight of the formulation.

4. The formulation of claim 1, wherein the one or more metal hydroxides is present in an amount of from about 30% to about 45% based on the total weight of the formulation.

5. The formulation of claim 1, wherein the one or more metal hydroxides is present in an amount of from about 35% to about 40% based on the total weight of the formulation.

6. The formulation of claim 1, wherein the one or more boron-containing compounds is present in an amount of about 2 to about 20% based on the total weight of the formulation.

7. The formulation of claim 1, wherein the one or more boron-containing compounds is present in an amount of about 5 to about 15% based on the total weight of the formulation.

8. The formulation of claim 1, wherein the one or more boron-containing compounds is present in an amount of about 5 to about 12% based on the total weight of the formulation.

9. The formulation of claim 1, wherein the one or more boron-containing compounds is present in an amount of about 5 to about 12% based on the total weight of the formulation.

10. The formulation of claim 1, wherein the one or more boron-containing compounds is present in an amount of about 5 to about 9% based on the total weight of the formulation.

11. The formulation of claim 1, wherein the one or more polyhydroxy compounds is present in an amount of about 2 to about 10% based on the total weight of the formulation.

12. The formulation of claim 1, wherein the one or more polyhydroxy compounds is present in an amount of about 4 to about 8% based on the total weight of the formulation.

13. The formulation of claim 1, wherein the one or more polyhydroxy compounds is present in an amount of about 5 to about 6% based on the total weight of the formulation.

14. A product comprising the formulation of claim 1, wherein the product comprises a cardboard box or a paper bag.

15. A process for preparing the formulation of claim 1, which comprises (1) mixing one or more polyhydroxy compounds and water to obtain a first solution, (2) mixing one or more metal hydroxides and the first solution to obtain a second solution, which may be optionally heated to a temperature of from about 60° to about 100° C., (3) mixing a boron-containing compound and the second solution to obtain a third solution, which may be optionally heated to a temperature of from about 60° C. to about 100° C., and (4) optionally cooling the third solution to room temperature.
